(19) United States
(12) Patent Application Publication
(10) Pub. No.: US 2003/0044554 A1
(43) Pub. Date: Mar. 6, 2003

(54) Fluorinated polypropylene container

(75) Inventor: Gregory M. Fehn, Diamond Lake, IL (US)

Correspondence Address: SONNENSCHEIN NATH & ROSENTHAL, P.O. BOX 061080, WACKER DRIVE STATION, CHICAGO, IL, 60606-1080, US

(73) Assignee: Consolidated Container Company.LLC.

(21) Appl. No.: 09/939,072

(22) Filed: Aug. 24, 2001

(51) Int. Cl. B32B 1/02

(52) U.S. Cl. 428/36.7; 428/35.7

(57) ABSTRACT

A fluorinated polypropylene container having a wall defining an interior and an exterior of the container, at least a portion of the wall having a plurality of layers including a first layer including polypropylene, and a second layer on the first layer, the second layer includes polyethylene and having a fluorinated surface facing an interior of the container.

### BACKGROUND OF THE INVENTION

The present invention generally relates to plastic containers. The present invention also relates to fluorinated plastic containers.

As is known, a film of fluorinated polymer can be adhered to the interior surface of a plastic container. The film does not necessarily comprise an additional layer, but may be formed by merely fluorinating an existing layer. Fluorination can be performed by, for example, contacting a polymer layer with a gas containing fluorine during formation of the container or in a step following container forming.

The fluorinated film serves to prevent an attack on or absorption by the interior surface of the container by products that the container may hold. This can include resistance to flavor scalping when the container holds comestibles. Also, the fluorinated film may serve as a barrier to other chemicals passing through the wall of the container. These chemicals can include external contaminants, as well as, chemicals within the walls of the container.

In known fluorinated containers, a fluorinated film is formed on the interior polyethylene surface. A separate exterior polyethylene layer is commonly used to incorporate reground bottle and/or trim scrap, color pigments, or other materials. If two layers are used, the interior polyethylene layer is formed to a thickness such that the interior polyethylene layer is about 10 percent by weight of the container and the exterior polyethylene layer is about 90 percent by weight of the container.

While this configuration is effective to prevent flavor scalping, such bottles made by an extrusion blow molding process have structural and aesthetic disadvantages.

Pursuant to the present inventors' analysis, the known containers exhibit reduced structural characteristics at a bottom seal of the containers. When the bottom seal is formed, the parison is pinched-off between two halves of the mold at a mold parting line. At the mold parting line, the interior polyethylene layer with its fluorinated surface is compressed together between the exterior polyethylene layers such that the fluorinated surface of interior polyethylene layers of the two mold halves meet at the bottom seal and, in some cases, at other seal locations. (See FIG. 4). However, the interface of the two fluorinated surfaces provides poor adhesion. Also, when the container is cooled after the bottom seal is formed, a depression forms at the mold parting line. This results in a reduced thickness at the mold parting line.

The combination of the fluorinated surface interface and the depression at the mold parting line produces a stress concentration at the depression which contributes to poor drop impact resistance.

Further, known containers do not have a clarity that is desirable by some users. This is a result of the polyethylene material, which has poor clarity.

### SUMMARY OF THE INVENTION

The present disclosure provides one or more inventions directed to improvements in fluorinated containers. These improvements can be practiced jointly or separately.

To this end, in an embodiment, there is provided a container comprising a wall defining an interior and an exterior of the container, at least a portion of the wall having a plurality of layers including: a first layer comprising polypropylene; and a second layer formed on the first layer, the second layer comprising polyethylene and having a fluorinated surface toward an interior of the container.

In an embodiment, the container further comprises a third layer on the first layer opposite the second layer.

In an embodiment, the first layer comprises at least one of post-consumer recycled polypropylene, reground scrap, and color pigment. For the purposes of this disclosure, unless otherwise noted, “reground scrap” is defined as reground bottle and/or trim scrap. The reground scrap can comprise polypropylene.

In an embodiment, the first layer comprises at least about 95 percent by weight of the container.

In an embodiment, the second layer comprises less than about 5 percent by weight of the container.

In an embodiment, the first layer comprises at least about 85 percent by weight of the container, and the third layer comprises about 10 percent by weight of the container.

In an embodiment, the first layer comprises at least about 75 percent by weight of the container, and the third layer comprises about 20 percent by weight of the container.

In embodiments, the third layer is a gloss layer and/or comprises color pigments.

The container can be used with various products, such as, for example, chemicals, aqueous products and/or comestibles including dry foods.

Further, in embodiments, additional layers are employed to provide gas barrier properties, as required by many food products. For example, in an embodiment, a gas barrier layer is provided between the first layer and the second layer. Alternatively, the gas barrier layer can be provided between the first layer and the third layer. Adhesive layers can be provided to adhere the gas barrier layer to adjacent layers. Further, the gas barrier layer can comprise, for example, at least one of EVOH and nylon.

There is also provided, in an embodiment, a method of forming a container having a wall defining an interior and an exterior of the container, at least a portion of the wall having a plurality of layers. The method comprises forming a first layer of the wall, the first layer comprising polypropylene; and forming a second layer of the wall on the first layer, the second layer comprising polyethylene and having a fluorinated surface toward an interior of the container. For the purposes of this disclosure, unless otherwise noted, “forming” is not limited to a molding step but otherwise comprises an entire process for producing a completed container. Forming comprises, for example, a parison formation step, a molding operation and/or possible subsequent steps of treating and/or configuring the container to produce a finished container.

In an embodiment, a third layer is formed on the first layer opposite the second layer.

In an embodiment, a bottom portion of the container is sealed.

In an embodiment, the second layer is fluorinated by contacting the surface of the second layer with a gas comprising fluorine. The gas can comprise, for example, less than about 10% fluorine. Also, the gas can comprise an inert or diluent gas of, for example, greater than about 90% nitrogen.

In embodiments, the wall is formed, for example, by blow molding, thermoforming, injection molding, or injection blow molding.

In an embodiment, the interior facing surface of the second layer is fluorinated during the forming of the wall of the container.

In an embodiment, the interior facing surface of the second layer is fluorinated after the forming of the wall of the container.

In an embodiment, wherein the wall of the container is formed by blow molding, a hollow parison is delivered into a blow mold, the hollow parison comprising the first layer and the second layer. A gas excluding fluorine is administered into a central portion of the hollow parison. The hollow parison is pinched-off between blow mold halves to form a bottom seal and, in some cases, other seals of the container. Other seals can include, for example, a seal at a handle portion. After pinching-off the hollow parison, a gas comprising fluorine is administered into a central portion of the hollow parison.

These and other features of the present invention will become clearer with reference to the following detailed description of the presently preferred embodiments and accompanying drawings.

### DESCRIPTION OF THE DRAWINGS

FIG. 1 is a schematic elevational view with parts shown in section of a conventional container forming apparatus including a parison-forming die, a parison and a blow mold.

FIG. 2 provides an enlarged cross-sectional view along the line 2-2 view of the layers forming a conventional container.

FIG. 3 is a cross-sectional view of a conventional container.

FIG. 4 provides an enlarged cross-sectional view along the line 4-4 view of the bottom seal of a conventional container.

FIG. 5 is a cross-sectional view of a container in accordance with the present invention.

FIG. 6 provides an enlarged cross-sectional view along the line 2-2 view of the layers forming a container in accordance with the present invention.

FIG. 7 provides an enlarged cross-sectional view along the line 7-7 view of the bottom seal of a container in accordance with the present invention.

FIG. 8 provides an enlarged cross-sectional view along the line 2-2 view of the layers forming a container in accordance with a further embodiment of the present invention.

FIG. 9 provides an enlarged cross-sectional view along the line 2-2 view of the layers forming a container in accordance with a further embodiment of the present invention.

FIG. 10 provides an enlarged cross-sectional view along the line 2-2 view of the layers forming a container in accordance with a further embodiment of the present invention.

FIG. 11 provides an enlarged cross-sectional view along the line 2-2 view of the layers forming a container in accordance with a further embodiment of the present invention.

### DETAILED DESCRIPTION OF THE PRESENTLY PREFERRED EMBODIMENTS

As discussed above, there is provided a fluorinated polypropylene container.

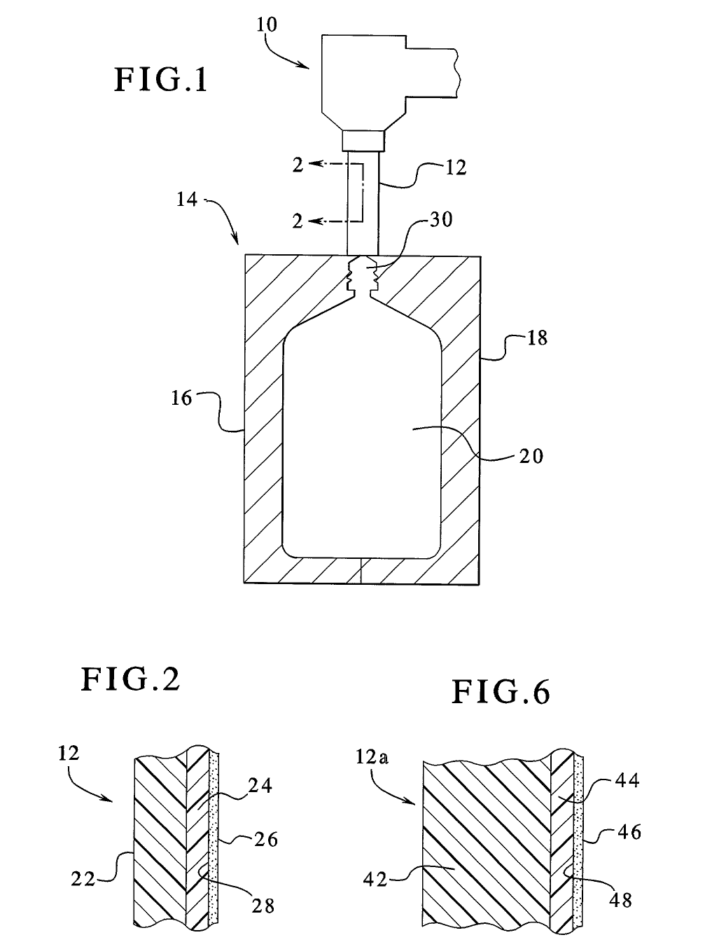

In FIG. 1, there is illustrated the head 10 of a conventional extruder used for delivering a multi-layered tubular parison 12 of plastic material in a blow molding process. The parison 12 is received in a split blow mold 14, which has two mold halves 16 and 18, for effecting the blow molding of a container 20.

The container 20 can be formed by another method such as injection blow molding, thermoforming, or injection molding.

In FIG. 2, there is illustrated a cross-sectional view along the line 2-2 view of the parison 12 used in forming a conventional container. As shown, the parison 12 of known containers has a thick exterior layer 22 of polyethylene and a thinner interior layer 24 of polyethylene having a fluorinated film 26 on its surface 28 toward the interior of the container 16.

The exterior polyethylene layer 22 of known containers is typically made of pigmented high density polyethylene (HDPE), which typically contains reground scrap, and is formed to a thickness such that the exterior polyethylene layer 22 comprises 90% of the weight of the container. Accordingly, the thickness ratio of the external polyethylene layer 22 to the interior polyethylene layer 24 is typically 9:1. The interior polyethylene layer 24 of known containers is also made of HDPE and is usually natural HDPE and typically does not include reground scrap or pigment. While this combination of polyethylene layers 22 and 24 provides an adequate platform for fluorination, it does not provide a value of clarity that is sufficient for all potential uses. The cloudy, thick exterior polyethylene layer 24 precludes these known containers 16 from uses that require substantially clear containers, even if not pigmented.

During the blow molding of the container 20, the fluorinated film 26 is formed on the surface 28 of the interior polyethylene layer 24 by, for example, contacting the surface 28 of the interior polyethylene layer 24 with a gas comprising fluorine. The gas is administered into a central portion of the tubular parison 12. Within the parison 12, the gas contacts the surface 28 of the interior polyethylene layer 24, thus fluorinating the surface 28.

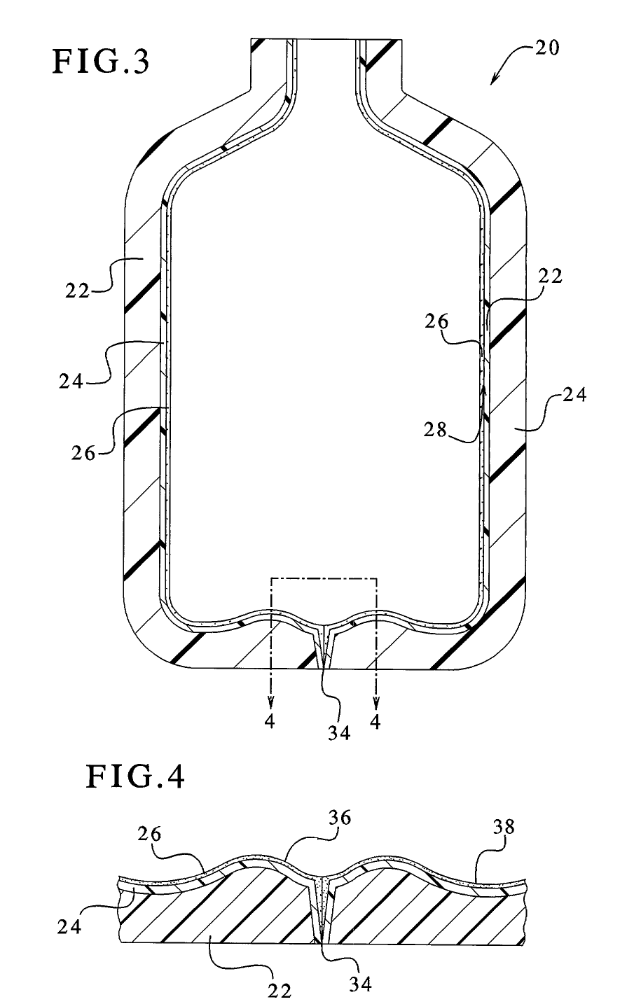

The parison 12 is pinched-off by the two mold halves 16 and 18 of the blow mold 14 to form a bottom seal 34 of the container 20. As illustrated in FIG. 3, the interior polyethylene layer 24 with the fluorinated film 26 on its fluorinated surface 28 is compressed together between the exterior polyethylene layer 22 such that the fluorinated film 26 at opposite sides of the parison 12 meets at the bottom seal 34.

In known containers 20, the interface of the fluorinated surfaces 28 provides a poor adhesion at the bottom seal 34. Further, when the container 20 is cooled after the bottom seal 34 is formed, a depression 36 forms on an inside surface 38 of the container 20 along the bottom seal 34. (FIG. 4). This results in localized, reduced thickness at the bottom seal 34. The combination of the fluorinated surface 28 interface and the depression 36 at the bottom seal 34 results in a disadvantageously reduced strength of the bottom seals 34 of known containers. Accordingly, the bottom seal 34 is subject to failure upon impact when the container 20 is dropped from a low height.

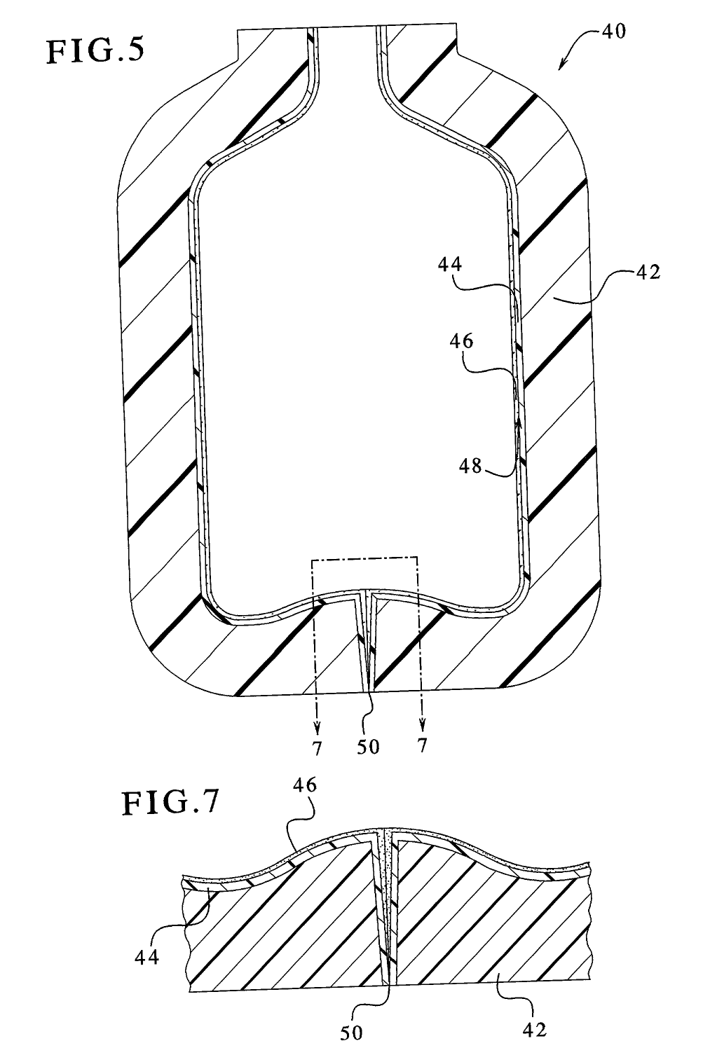

Referring to FIG. 5, Applicant inventively overcomes these known disadvantages by providing a container 40 that comprises an exterior polypropylene layer 42, which can comprise reground scrap, formed to a thickness such that the exterior polypropylene layer 42 comprises about 95% of the weight of the container 40. The exterior polypropylene layer 42 of the present invention replaces the exterior polyethylene layer 22 of the known containers 20.

FIG. 6 illustrates a cross-sectional view of a parison 12a used in forming a container in accordance with the present invention. The parison 12a of present container comprises an exterior polypropylene layer 42 and a thinner interior layer 44 of polyethylene having a fluorinated film 46 on its surface 48 facing toward the interior of the container 40.

The exterior polypropylene layer 42 is formed to a thickness such that the exterior polypropylene layer 42 comprises about 95% of the weight of the container 40. Accordingly, the thickness ratio of the external polypropylene layer 42 to the interior polyethylene layer 44 is about 19:1. The exterior polypropylene layer 42 can comprise, for example, natural polypropylene. However, the exterior polypropylene layer 42 can comprise other materials, such as, for example, reground scrap, and/or comprise a plurality of layers. For example, in an embodiment, the exterior polypropylene layer 42 comprises post-consumer recycled polypropylene, i.e. polypropylene which is reprocessed after an initial use.

In providing an external polypropylene layer 42, the present invention exhibits improved clarity over known all polyethylene containers. The thick external polypropylene layer 42 of the present container 40 provides a more light transmissive medium than polyethylene, which clarity is desirable for applications and currently unavailable with known all polyethylene containers. The fluorination of polypropylene results in fluorinated components which have uncertain properties and interactions with food products. The U.S. Food and Drug Administration does not currently sanction fluorinated polypropylene for direct food contact. (See 21 C.F.R. §177.1615). Therefore, in the present container 40, inventively, the interior polyethylene layer 44 is fluorinated and formed on a surface of the exterior polypropylene layer 42.

The interior polyethylene layer 44 of the present container is formed of, for example, natural HDPE. However, the interior polyethylene layer 44 can comprise other and/or additional types of materials, such as LDPE, as well as additional layers.

A gas comprising fluorine is contacted against the surface 48 of the interior polyethylene layer 44 to form the fluorinated film 46. In an embodiment, the gas comprises less than about 10% fluorine and greater than about 90% diluent gas. In another embodiment, the gas comprises from about 2% to about 8% fluorine with the balance consisting essentially of an inert gas. In yet another embodiment, the gas comprises from about 4% to about 5% fluorine with the balance consisting essentially of a diluent gas. In a further embodiment, the gas comprises less than about 6% fluorine and greater than about 94% inert gas. The inert gas can comprise, for example, nitrogen, argon, helium, or a mixture of inert gases. The gas can comprise other materials in addition to fluorine and the inert gas. In practice, much less than 1% of the fluorine reacts with the surface 40 and the remainder is exhausted following the container forming process. U.S. Pat. No. 6,194,043 B1, issued Feb. 27, 2001 to Gregory M. Fehn, discloses a container having a film of fluorinated polyethylene, which reference is incorporated herein by reference.

As described above, the fluorinated film 46 beneficially prevents the scalping of flavors and odors from the contents of the container and further inhibits transmission of chemicals into the contents of the container through the interior polyethylene layer 44.

The present container 40 can be formed by a method similar to the methods used for known containers 20, such as by blow molding, thermoforming, injection molding, or injection blow molding. Similar to known containers 20, when the present container 40 is formed by blow molding, a bottom seal 50 is formed. Unlike known containers 20 made from polyethylene, however, when the present container 40 cools, no depression forms at the bottom seal 50. Referring to FIG. 7, the bottom seal 50 maintains a thickness which is generally greater than an average thickness of the bottom surface of the container 40. Therefore, the present container 40 inventively provides reduced stress concentration at the bottom seal 50 compared to known containers.

In drop tests performed in accordance with the Bruceton Staircase Method (ASTM Procedure D2463-95) to determine mean failure height, the present container 40 exhibited significantly greater drop impact resistance over a known container 20. The known container 20 used in the tests comprised interior and exterior polyethylene layers 24 and 22 of Paxon AK53-004 with a fluorinated interior surface 28. The present container 40 used in the tests comprised a fluorine-treated interior polyethylene layer 44 of Paxon AK53-004 and an exterior polypropylene layer 42 of Solvay KB5180. Both the exterior polypropylene layer 22 of the known container 20 and the exterior polypropylene layer 42 of the present container 40 contained reground scrap. At 73° F., the known container 20 had a mean failure height of 9.25 feet while the present container exhibited a mean failure height of 12.63 feet.

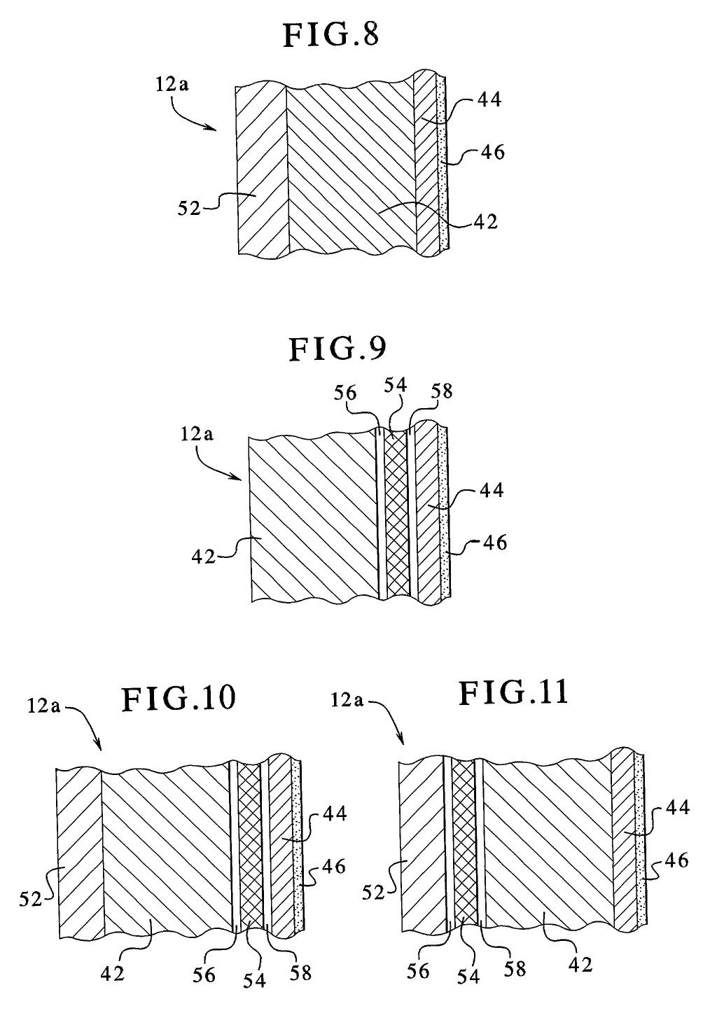

Referring to FIG. 8, in an embodiment, the container 40 comprises a second polypropylene layer 52 formed on a surface of the exterior polypropylene layer 42 opposite the interior polyethylene layer 44. The second polypropylene layer 52 can comprise any desired polypropylene compound suitable for the desired application. For example, the second polypropylene layer 52 can comprise at least one of pure polypropylene, reground scrap, and post-consumer recycled polypropylene comprising reground scrap. Further, in an embodiment, the second polypropylene layer 52 is a gloss layer. In another embodiment, the second polypropylene layer 52 comprises color pigments.

As discussed above, the interior polyethylene layer 44 comprises less than about 5% by weight of the container 40. When the container comprises a second polypropylene layer 52, the percent weight value of the exterior polypropylene container 42 is reduced to accommodate the desired percent weight value of the second polypropylene layer 52. In other words, the interior polyethylene layer 44 continues to comprise less than about 5% by weight of the container 40 when the container comprises a second polypropylene layer 52.

In an embodiment, the exterior polypropylene layer 42 comprises, for example, at least about 85% by weight of the container 40 and the second polypropylene layer 52 comprises about 10% by weight of the container 40. In this embodiment, the second polypropylene layer 52 can be, for example, a gloss layer. In another embodiment, the exterior polypropylene layer 42 comprises, for example, at least about 75% by weight of the container 40 and the second polypropylene layer 52 comprises about 20% by weight of the container 40. In this embodiment, the second polypropylene layer 52 can comprise, for example, color pigments.

In alternative embodiments, the second polypropylene layer 52 has a higher value weight percent of the container 40 than the exterior polypropylene layer 42. For example, in an embodiment, the exterior polypropylene layer 42 comprises, for example, at least about 10% by weight of the container 40 and the second polypropylene layer 52 comprises about 85% by weight of the container 40.

In an embodiment, the container 40 comprises at least one gas barrier layer 54. In the embodiment shown in FIG. 9, the gas barrier layer 54 is formed between the exterior polypropylene layer 42 and the interior polyethylene layer 44. As is known, gas barrier layers resist gases, such as oxygen, from permeating through the wall of a container. In the embodiment illustrated in FIG. 9 the gas barrier layer 54 is secured to the exterior polypropylene layer 42 via a first adhesive layer 56 and to the inter polyethylene layer 44 via a second adhesive layer 58.

The gas barrier layer 54 can comprise any material suitable for providing gas barrier resistance, such as, for example, EVOH or nylon. Further, the gas barrier layer 54 can comprise a plurality of gas barrier layers.

In an embodiment, as illustrated in FIG. 10, the second polypropylene layer 52 can be formed on one surface of the exterior polypropylene layer 42 and the gas barrier layer 54, which may include first and second adhesive layers 56 and 58, can be formed on an opposite surface of the exterior polypropylene layer 42.

In an embodiment, as illustrated in FIG. 11, the gas barrier layer 54, which may include first and second adhesive layers 56 and 58, can be formed between the second polypropylene layer 52 and the exterior polypropylene layer 42.

In further embodiments, the present container 40 can comprise additional layers, such as, gloss layers, gas barrier layers, adhesive layers, polyolefin layers, and/or polyesther layers. For example, in an embodiment, the present container 40 can comprise a first gas barrier layer 54 formed between the second polypropylene layer 52 and the exterior polypropylene layer 42 and a second gas barrier layer (not shown) formed between the exterior polypropylene layer 42 and the interior polyethylene layer 44.

In another embodiment, during the blow molding of the container 40, the parison 12a initially filled with a gas that does not comprise fluorine. Then after the bottom seal is formed by pinching-off the parison 12a between the two mold halves 16 and 18, a gas comprising fluorine is administered into a central portion of the tubular parison 12a to inflate the parison 12a within the two mold halves 16 and 18 to form the container 40.

The above-described embodiments relate to a container 40 formed by blow molding. In other embodiments, the container 40 can be formed by, for example, injection blow molding, injection molding, or thermoforming. Further, the container can first be formed and then fluorinated in a subsequent step.

For example, in an embodiment, the container 40 is formed by injection blow molding. A “core” comprising an interior polyethylene layer 44 and an exterior polypropylene layer 42 is injected into a receptacle. Then, the core removed from the receptacle and inflated through a blow molding step into the shape of the container 40. During the blow molding step, a gas comprising fluorine is contacted against the surface 48 of the interior polyethylene layer 44 to form the fluorinated film 46. The container 40 can comprise additional layers as discussed in the above-described embodiments.

In yet another embodiment, an already formed container 40 is fluorinated. After the container 40 is formed, the fluorinated film 26 is formed on at least the surface 28 of the interior polyethylene layer 24 with a gas comprising fluorine. During the fluorination, a fluorinated film can be formed on all of the surfaces of the container 40, however, it is significant that the fluorinated film 26 is formed on at least the surface 28 of the interior polyethylene layer 24. This embodiment is effective to provide a fluorinated surface on an already existing container 40.

The foregoing provides a container with sufficient fluorination that has improved clarity, improved drop impact resistance, and can meet the requirements of the U.S. Food and Drug Administration. In an experiment, three one-gallon bottles A, B, C formed in accordance with the present invention and having an inside fluorine-treated polyethylene surface were prepared for extraction of fluorine in accordance with 21 C.F.R. §177.1615 and 21 C.F.R. §176.170 (table 2—item c) (Apr. 1, 2001 Ed.). The Ion Chromatography extraction results for detection limits of 0.1 ppm and 0.01 ppm flouride ion are shown in the following table. The acceptable limit is 5 ppm fluoride ion. 21 C.F.R. §177.1615(c).

Detection Limit

| Container | 0.1 ppm | 0.01 ppm |
|---|---|---|
| A | none | 0.03 |
| B | none | 0.01 |
| C | none | none |

As is apparent from the foregoing specification, the present invention is susceptible to being embodied with various alterations and modifications which may differ particularly from those that have been described in the preceding specification and description. It should be understood that it is desired to embody within the scope of the patent warranted herein all such modifications as reasonably and properly come within the scope of the presently defined contribution to the art.

We claim as our invention:

1. A container comprising:
a wall defining an interior and an exterior of the container, at least a portion of the wall having a plurality of layers including:
a first layer comprising polypropylene; and
a second layer formed on the first layer, the second layer comprising polyethylene and having a fluorinated surface facing an interior of the container.

2. The container of claim 1, further comprising a third layer formed on the first layer opposite the second layer.

3. The container of claim 1, wherein the first layer comprises at least one of post-consumer recycled polypropylene, reground scrap, and color pigment.

4. The container of claim 1, wherein the first layer comprises at least about 95 percent by weight of the container.

5. The container of claim 2, wherein the first layer comprises at least about 85 percent by weight of the container, and wherein the third layer comprises about 10 percent by weight of the container.

6. The container of claim 2, wherein the first layer comprises at least about 75 percent by weight of the container, and wherein the third layer comprises about 20 percent by weight of the container.

7. The container of claim 5, wherein the third layer is a polypropylene gloss layer and the first layer comprises a color pigment.

8. The container of claim 6, wherein the third layer comprises color pigments.

9. The container of claim 1, wherein the second layer comprises less than about 5 percent by weight of the container.

10. The container of claim 1, wherein the container is blow molded.

11. The container of claim 1, wherein the container is thermofolded.

12. The container of claim 1, wherein the container is injection molded.

13. The container of claim 1, wherein the container is injection blow molded.

14. The container of claim 1, wherein the container is used with an aqueous product.

15. The container of claim 1, wherein the container is used with a comestible.

16. The container of claim 1, wherein the container is used with a chemical product.

17. The container of claim 1, further comprising at least one gas barrier layer formed between the first layer and the second layer.

18. The container of claim 17, further comprising a first adhesive layer and a second adhesive layer formed on opposite surfaces of and in intimate contact with the gas barrier layer.

19. The container of claim 18, wherein the gas barrier layer comprises at least one of EVOH and nylon.

20. The container of claim 2, further comprising at least one gas barrier layer formed between the first layer and the third layer.

21. The container of claim 20, further comprising a first adhesive layer and a second adhesive layer formed on opposite surfaces of and in intimate contact with the gas barrier layer.

22. The container of claim 21, wherein the gas barrier layer comprises at least one of EVOH and nylon.

23. A method of forming a container having a wall defining an interior and an exterior of the container, at least a portion of the wall having a plurality of layers, the method comprising the steps of:
forming a first layer of the wall, the first layer comprising polypropylene; and
forming a second layer of the wall on the first layer, the second layer comprising polyethylene and having a fluorinated surface toward an interior of the container.

24. The method of claim 23, further comprising the steps of:
forming a third layer on the first layer opposite the second layer.

25. The method of claim 23, further comprising the step of:
sealing a bottom portion of the container.

26. The method of claim 23, further comprising the step of:
fluorinating the second layer by exposing an interior facing surface of the second layer with a gas comprising fluorine.

27. The method of claim 26, wherein the gas comprises less than about 10% fluorine.

28. The method of claim 26, wherein the gas comprises greater than about 90% inert gas.

29. The method of claim 23, wherein the first layer comprises at least one of post-consumer recycled polypropylene and reground scrap comprising polypropylene.

30. The method of claim 23, wherein the first layer comprises at least about 95 percent by weight of the container.

31. The method of claim 24, wherein the first layer comprises at least about 85 percent by weight of the container, and wherein the third layer comprises about 10 percent by weight of the container.

32. The method of claim 24, wherein the first layer comprises at least about 75 percent by weight of the container, and wherein the third layer comprises about 20 percent by weight of the container.

33. The method of claim 24, wherein the third layer is a polypropylene gloss layer and the first layer contains a color pigment.

34. The method of claim 24, wherein the third layer comprises color pigments.

35. The method of claim 23, wherein the second layer comprises less than about 5 percent by weight of the container.

36. The method of claim 23, further comprising the steps of:
forming at least one gas barrier layer between the first layer and the second layer.

37. The method of claim 36, further comprising the steps of:
forming a first adhesive layer and a second adhesive layer on opposite surfaces of and in intimate contact with the gas barrier layer.

38. The method of claim 23, wherein the gas barrier layer comprises at least one of EVOH and nylon.

39. The method of claim 24, further comprising the steps of:
forming at least one gas barrier layer between the first layer and the third layer.

40. The method of claim 39, further comprising the steps of:
forming a first adhesive layer and a second adhesive layer on opposite surfaces of and in intimate contact with the gas barrier layer.

41. The method of claim 39, wherein the gas barrier layer comprises at least one of EVOH and nylon.

42. The method of claim 23, wherein the wall is formed by blow molding.

43. The method of claim 23, wherein the wall is formed by thermoforming.

44. The method of claim 23, wherein the wall is formed by injection molding.

45. The method of claim 23, wherein the wall is formed by injection blow molding.

46. The method of claim 26, wherein the interior facing surface of the second layer is fluorinated during the forming of the wall of the container.

47. The method of claim 26, wherein the interior facing surface of the second layer is fluorinated after the forming of the wall of the container.

48. The method of claim 23,
wherein the wall of the container is formed by blow molding; and
the method further comprising the steps of:
delivering a hollow parison into a blow mold, the hollow parison comprising the first layer and the second layer;
administering a gas excluding fluorine into a central portion of the hollow parison;
pinching-off the hollow parison between blow mold halves to form at least a bottom seal of the container; and
after pinching-off the hollow parison, administering a gas comprising fluorine into a central portion of the hollow parison.

49. The method of claim 23, further comprising the step of: sealing a portion of the container.
